(19) United States
(12) Patent Application Publication
(10) Pub. No.: US 2011/0151879 A1
(43) Pub. Date: Jun. 23, 2011

(54) System and Method for Alternate Mobility Call Routing

(76) Inventors: Moshiur Rahman, Marlboro, NJ (US); Paritosh Bajpay, Edison, NJ (US)

(21) Appl. No.: 12/645,795

(22) Filed: Dec. 23, 2009

(51) Int. Cl. H04W 40/00

(52) U.S. Cl. 455/445

(57) ABSTRACT

A computer readable storage medium stores a set of instructions executable by a processor. The set of instructions being operable to receive, from a communications network, an indication that an element of the network is at a capacity limit; and initiate a communications session from a user communication device using an alternative network, wherein the alternative network transmits the communications session to the communications network.

### BACKGROUND

During peak hours, emergencies, and other situations, mobile communications networks may experience significant congestion. This congestion may lead to delays, inability to connect communication sessions, dropped sessions, etc. In such situations, it is advantageous to have an alternative routing path available in order to be able to complete such sessions successfully.

### SUMMARY OF THE INVENTION

A computer readable storage medium stores a set of instructions executable by a processor. The set of instructions being operable to receive, from a communications network, an indication that an element of the network is at a capacity limit; and initiate a communications session from a user communication device using an alternative network, wherein the alternative network transmits the communications session to the communications network.

A communications device includes a memory, first and second communications links, and a processor. The processor is configured to receive an instruction via the first communications link to conduct communications via the second communications link. The processor is further configured to initiate a communications session via the second communications link.

A network device of a communications network includes a memory and a processor. The processor is configured to determine that a network access point of the communications network has reached a capacity limit. The processor is further configured to instruct a user device to initiate a communications session via a secondary network. The processor is further configured to receive an indication that the communications session has been initiated via the secondary network.

### BRIEF DESCRIPTION OF THE DRAWINGS

FIG. 1 shows an exemplary communications network.

FIG. 2 shows an exemplary method for providing an alternative call routing to a mobile device in a communications network such as the exemplary network of FIG. 1.

### DETAILED DESCRIPTION

The exemplary embodiments may be further understood with reference to the following description and the appended drawings, wherein like elements are referred to with the same reference numerals. The exemplary embodiments describe methods and systems for providing alternative call routing in situations when a cellular phone or other mobile device may be unable to complete a call due to a lack of network capacity. In the exemplary embodiments, calls are routed via a GPS receiver that is linked to the mobile device.

During peak hours, emergencies, and other high-traffic situations, mobile communications networks may experience significant congestion. This congestion may lead to delays, inability to connect communication sessions, dropped sessions, etc. In particular, such congestion may occur at a single base station, which may be unable to handle traffic as a result. In such situations, it is advantageous to have an alternative routing path available in order to be able to complete such sessions successfully.

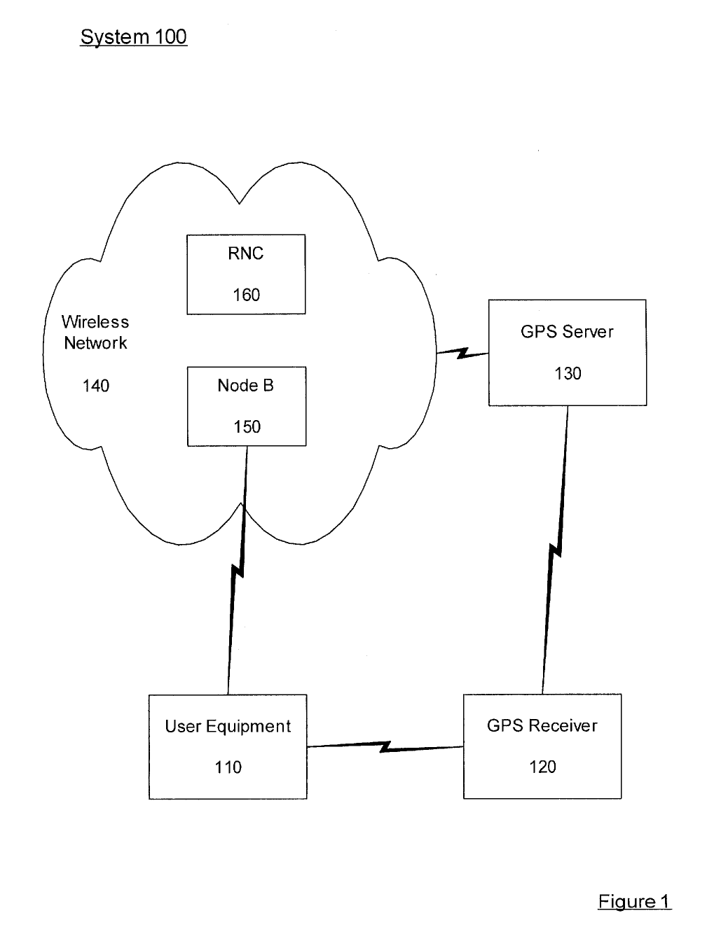

FIG. 1 illustrates an exemplary system 100. The system 100 includes user equipment 110, which may include, for example, a cellular phone, a smart phone, or another personal communications device. The user equipment 110 is in bi-directional contact with a GPS receiver 120. In one embodiment, the GPS receiver 120 and the user equipment 110 may form a single device (e.g., a mobile phone with integrated GPS), may communicate wirelessly (e.g., via a personal area network (“PAN”) such as a Bluetooth network), may share a wired communication, or may be linked in any other manner to allow bi-directional communication. The GPS receiver 120 is in wireless bi-directional communication with a GPS server 130; in addition to navigational data, this communication link may also be capable of transmitting other types of data.

The system 100 also includes a wireless network 140 accessible by the user equipment 110. In one embodiment, this may be a cellular phone network or a mobility network. In one embodiment, the wireless network 140 may be a universal mobile telecommunications system (“UMTS”) network. The wireless network 140 may include a plurality of Node B components 150, which may directly communicate with devices such as the user equipment 110. The wireless network 140 may further include a plurality of radio network controllers (“RNC”) 160, which may coordinate the operations of the wireless network 140. For simplicity, FIG. 1 illustrates only one Node B 150 and one RNC 160, but those of skill in the art will understand that other such networks may include significantly more of each element and any number of additional network elements to provide the functionality of the wireless network 140. The wireless network 140 is also capable of bi-directional data communication with the GPS server 130. While the communication is illustrated as wireless in FIG. 1, the GPS server 130 may communicate via a wired connection with a component of the wireless network 140.

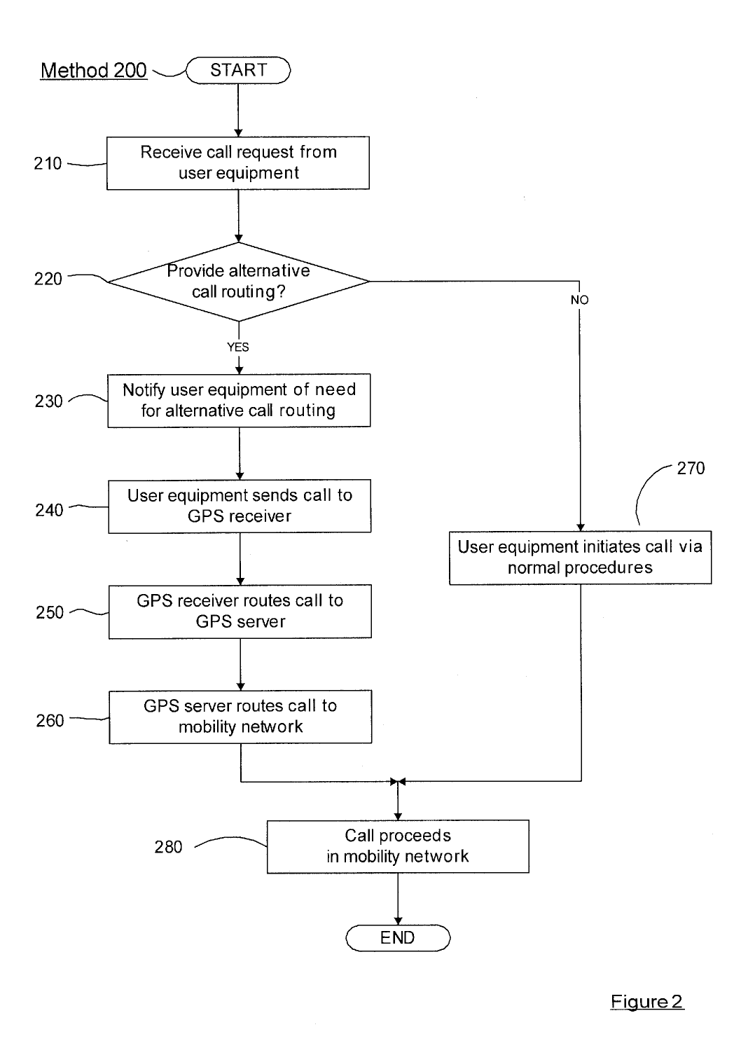

FIG. 2 illustrates an exemplary method 200 by which alternative call routing may be provided for user equipment such as the user equipment 110 of FIG. 1. The method 200 will be described specifically with reference to the system 100 of FIG. 1; however, those of skill in the art will understand that the broader principles may be equally applicable to various other types of systems.

In step 210, the user equipment 110 attempts to route a communication session (e.g., a phone call) through the network 140 by contacting Node B 150. This may be, for example, a newly initiated communication session or a session that is being handed over from a different Node B to the Node B 150. In step 220, the RNC 160 receives the request to route the communication session and determines whether to use the network 140 to handle the communication session, or whether to provide alternative call routing as will be described below. In one embodiment, this determination may be made based on a routing or bandwidth capacity of the network 140 and/or a quality of service guaranteed for the user. In another embodiment, the RNC 160 may determine that alternative call routing is appropriate if the call being initiated is a priority call that may merit special treatment.

If the RNC 160 determines that alternative call routing should be provided, then, in step 230, the RNC 160 notifies the user equipment 110 of this determination. This may be accomplished, for example, via the Node B 150. Next, in step 240, the user equipment 110, which may be pre-provisioned for alternative routing as described herein, sends data relating to the communication session to the GPS receiver 120. Those of skill in the art will understand that the nature of this data transfer depends on the nature of the connection between the user equipment 110 and the GPS receiver 120; for example, where the user equipment 110 and GPS receiver 120 are integrated into a single device, data may be sent via an internal bus, whereas if the user equipment 110 and the GPS receiver 120 are linked via a network (e.g., a wireless PAN), data may be sent via the network.

Upon receiving this data, in step 250 the GPS receiver 120, which may also be pre-provisioned for this function, transmits the data via its link to the GPS server 130; as stated above, the communication link between the GPS receiver 120 and the GPS server 130 may be capable of carrying additional data beyond the standard navigational data. Next, in step 260, the GPS server 130, which may also be pre-provisioned to carry data traffic for communications sessions in this manner, sends the received data to the network 140. The transmission of data from the GPS server 130 to the wireless network 140 may be accomplished by any type of communication link that may be capable of such transmission; in one embodiment, transmission may be accomplished via an IP network (e.g., the Internet).

Alternately, if, in step 220, the RNC 160 determined that alternate call routing was not required, then, in step 270, the user equipment 110 initiates communications via the Node B 150 using normal procedures. As stated above, initiation of communications in this context may signify either the creation of a new communication session or the handoff of an existing communication session to the Node B 150. After either step 260 or step 270, the method continues in step 280, where the communication session proceeds within the wireless network 140 using normal procedures. After step 280, the method terminates.

The exemplary embodiments provide an alternative call routing path that may avoid congestion if elements of a network, such as the Node B 150 of FIG. 1, have reached capacity. The exemplary embodiments may also provide selective alternative routing for high-priority communication sessions. This may be accomplished using components that are typically collocated with user equipment, such as the GPS receiver 120 of FIG. 1. As a result, a communication network may be rendered more robust, improving performance and customer satisfaction.

It will be apparent to those skilled in the art that various modifications may be made in the present invention, without departing from the spirit or the scope of the invention. Thus, it is intended that the present invention cover modifications and variations of this invention provided they come within the scope of the appended claims and their equivalents.

What is claimed is:

1. A computer readable storage medium storing a set of instructions executable by a processor, the set of instructions being operable to:
receive, from a communications network, an indication that an element of the network is at a capacity limit; and
initiate a communications session from a user communication device using an alternative network, wherein the alternative network transmits the communications session to the communications network.

2. The computer readable storage medium of claim 1, wherein the communications network is a cellular phone network.

3. The computer readable storage medium of claim 1, wherein the alternative network is a GPS network.

4. The computer readable storage medium of claim 3, wherein the communications session is initiated via a GPS receiver.

5. The computer readable storage medium of claim 4, wherein the GPS receiver is integrated with the user communication device.

6. The computer readable storage medium of claim 4, wherein the GPS receiver communicates with the user communication device by a network connection.

7. The computer readable storage medium of claim 6, wherein the network connection is a personal area network connection.

8. The computer readable storage medium of claim 1, wherein the element of the network is a Node B base station.

9. A communications device, comprising:
a memory;
first and second communications links; and
a processor configured to receive an instruction via the first communications link to conduct communications via the second communications link, the processor further configured to initiate a communications session via the second communications link.

10. The communications device of claim 9, wherein the first communications link is a cellular transceiver.

11. The communications device of claim 9, wherein the second communications link is a personal area network transceiver.

12. The communications device of claim 9, wherein the communications session is initiated with a GPS receiver.

13. The communications device of claim 12, wherein the GPS receiver is integrated with the communications device.

14. The communications device of claim 12, wherein the processor is further configured to instruct the GPS receiver to relay the communications session to a GPS server.

15. The communications device of claim 14, wherein the processor is further configured to instruct the GPS server to relay the communications session to a communications network.

16. The communications device of claim 9, wherein the instruction instructs the processor to conduct communications via the second communications link because of congestion of a network in communication with the first communications link.

17. The communications device of claim 9, wherein the instruction instructs the processor to conduct communications via the second communications link because of a priority of the communications session.

18. A network device of a communications network, comprising:
a memory; and
a processor configured to determine that a network access point of the communications network has reached a capacity limit, the processor further configured to instruct a user device to initiate a communications session via a secondary network, the processor further configured to receive an indication that the communications session has been initiated via the secondary network.

19. The network device of claim 18, wherein the secondary network is a GPS network.

20. The network device of claim 18, wherein the communications network is a UMTS network.
